(19) United States
(12) Patent Application Publication
(10) Pub. No.: US 2007/0165283 A1
(43) Pub. Date: Jul. 19, 2007

(54) Image forming apparatus, image processing method thereof and storage medium storing program for image processing

(75) Inventors: Yoshiki Matsuzaki, Kanagawa (JP); Takeshi Kato, Kanagawa (JP); Kazuhiro Hama, Kanagawa (JP); Toshiki Matsui, Kanagawa (JP); Takeshi Saito, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/516,567

(22) Filed: Sep. 7, 2006

(30) Foreign Application Priority Data
Jan. 19, 2006 (JP) 2006-011701

(51) Int. Cl. G06K 15/00; G06T 5/00

(52) U.S. Cl. 358/3.26

(57) ABSTRACT

An image forming apparatus that performs registration control when forming an image on a recording medium includes: a correction value determining unit that determines correction values for correcting misregistration of an image; an image processing unit that alters at least a part of a pattern included in the image based on the correction values determined by the correction value determining unit; and a correction processing unit that performs alteration on the image, in which at least a part of the pattern has been altered by the image processing unit, based on the correction values determined by the correction value determining unit.

### BACKGROUND

1. Technical Field

The present invention relates to an image forming apparatus such as printers, copiers, and the like as well as an image processing method thereof. More particularly, the invention relates to an image forming apparatus that carries out registration control, as well as an image processing method thereof and a storage medium that stores a program for image processing.

2. Related Art

In image forming equipment such as printers and copiers, when a recording medium such as paper is carried into image forming units, if it slants or warps in respect to the image forming units, the slant or warp results in misalignment of an image formed on the recording medium. Fitting error of the image forming units also causes misalignment of an image formation position in regard to the recording medium. To correct such misalignment of image formation, registration control has been performed conventionally.

As common image forming equipment for color image output, which prevails widely today, there is a so-called tandem type image forming apparatus in which the image forming units provided respectively for specific colors, for example, black (K), yellow (Y), magenta (M), and cyan (C) are serially arranged so as to face and contact an object onto which an image is transferred (such as a transfer belt as an intermediate transfer member and paper as a printing material). In this tandem type image forming apparatus, images of each different color formed by each image forming unit are sequentially transferred onto the moving transfer object and merged into a multi-color image.

In the tandem type image forming apparatus, because a multi-color image is formed by merging individual color images formed separately for each color in an overlap manner, out-of-color registration may occur in the multi-color image thus formed because of a fitting error of each image forming unit, an error in the circumferential velocity of each image forming unit, a difference of light illumination position on the transfer object, a variation in the linear speed of the transfer object, etc. This type of image forming apparatus always needs to measure the amount of color misregistration and perform color registration control to restrain the occurrence of out-of-color registration. Besides the above-mentioned tandem type image forming apparatus, in other types of image forming apparatus, for example, a cycle type in which a multi-color image is formed through multiple rotating units of image carriers and a so-called ink jet type, the same problem with regard to color misregistration and the like exits.

Image misalignment to be rectified by the above registration control (including color registration control) (this kind of misalignment will be referred to as misregistration) is classified into some types which are caused by a skew and bow of the scanning line and caused by magnification variation. Diverse techniques exist to correct these misregistrations; some rectify misregistration by the mechanism in the mechanical and optical systems and others correct misregistration by image processing by which original image data is altered according to the direction and amount of the misregistration. Since the mechanical rectification by the mechanical and optical systems requires very high precision, the correction by image processing with regard to minor rectification is less costly and more convenient.

FIGS. 20A and 20B are diagrams to explain a correction method by image processing for misalignment caused by a skew (hereinafter, this misregistration will be referred to as skew misregistration) among the above-mentioned types of misregistrations.

When skew misregistration is corrected by image processing, the image is altered to compensate for the amount of the skew misregistration in the output image, as noted above. Specifically, the pixels of the image shown in FIG. 20A are divided into blocks by an appropriate fraction of the width in the fast-scanning direction. As is shown in FIG. 20B, the pixels in each block are collectively shifted by an equal distance block by block in the slow-scanning direction, thereby the image is rectified and output. In the example shown here, the pixels in the A-R range in the fast-scanning direction into three blocks of an A-F fraction, a G-L fraction, and an M-R fraction of the range and each next block is shifted by one pixel with regard to the preceding block.

FIGS. 21A and 21B are diagrams to explain a correction method by image processing for misalignment caused by a magnification variation (hereinafter, this misregistration will be referred to as magnification deviation) among the above-mentioned types of misregistrations. While some magnification deviation may appear in the fast-scanning direction and some may appear in the slow-scanning direction, the example show here exemplifies the correction method for the magnification deviation that appears in the fast-scanning direction (fast scan magnification deviation).

When magnification deviation is corrected by image processing, the image is altered to compensate for the amount of the magnification deviation in the output image, as noted above. Specifically, pixels are appropriately added to (deleted from) the image shown in FIG. 21A, thereby the image is rectified and output, as shown in FIG. 21B. In the example shown here, correction is made such that two pixels (depicted by gray) in length are added to the image length of 16 pixels (A-P) in the fast-scanning direction, thereby elongating the length to 18 pixels (A-R). Depending on the case of misregistration, correction may be reducing the image by deleting (cutting) some pixels in length from the image, inversely to the example shown here.

FIG. 22 shows a general structure of image processing functions for this kind of related art. The image forming apparatus implements the functions shown here by a controller installed inside the apparatus and makes correction for misregistration.

As shown in FIG. 22, the controller 800 includes an image data generating unit 801, a screening unit 802, a misregistration detecting unit 803, a correction value determining unit 804, and a correction processing unit 805.

The image data generating unit 801 receives input of an image described in a page description language or bitmap data and converts the input image into a multilevel image, for example, in eight bits (256 gray-scale levels). The screening unit 802 converts the multilevel image into a binary image in 1 bit (two gray-scale levels). The misregistration detecting unit 803 detects whether misregistration occurs and the degree of misregistration (the direction and amount of misregistration) from the result of registration mark detection by a sensor. The correction value determining unit 804 calculates correction values by image processing, based on the result of detection by the misregistration detecting unit 803. The correction processing unit 805 performs correction (image processing) on the binary image output from the screening unit 802, according to the correction values calculated by the correction value determining unit 804. The thus corrected image output from the correction processing unit 805 is formed (printed) on a recording medium such as paper.

Meanwhile, in the current image forming equipment, an area coverage modulation method is often used as a standard method for representing a multilevel image. For example, an output image is first represented as a multilevel image at a 600 dpi resolution, using 8 bits (for 256 gray-scale levels)+tag (4 bits), and this image is screened and converted into a binary image at a 2400 dpi resolution, using 1 bit (for two gray-scale levels). In other words, one dot with a gray-scale value in the multilevel image is represented by a collection of 16 binary dots. In the screening, a regular screening pattern as is shown in FIG. 18 is formed across the segments of an image, corresponding to the tone levels of the segments.

As described above, at the present day, it is generally practiced to make correction for misregistration by image processing. The area coverage modulation method is generally used to represent a multilevel image.

However, when misregistration correction by image processing is performed on an image screened for the multilevel representation by the area coverage modulation method, a defect (in terms of image quality) may occur in the image due to deformation of the screening pattern formed in the image.

FIGS. 23A to 23C schematize defects which occur in an image when skew correction is performed.

FIGS. 23B and 23C respectively show image states after skew correction (pixel shifting) on an original black and white image in which a screening pattern is formed, as shown in FIG. 23A. A black streak defect appears in the image shown in FIG. 23B, whereas a white streak defect appears in the image shown in FIG. 23C.

FIGS. 24A and 24B illustrate images before and after inserting pixels into image data to correct magnification deviation in the fast-scanning direction.

In the example shown in FIGS. 24A and 24B, three pixels are inserted per line of fast scan. Pixel insertion positions (gray cells) are shown in FIG. 24A, whereas FIG. 24B shows the image where pixels (black cells) have been inserted at the right side of each insertion position shown in FIG. 24A. As shown in FIGS. 24A and 24B, when pixels are inserted in the corresponding positions along each scan line, the inserted pixels are lined up in the slow-scanning direction. Consequently, these pixels make a formation which is not ignorable in a macro perspective and a streak defect which is so apparent as to be visually perceivable takes place.

FIGS. 25A and 25B illustrate pixel insertion positions (FIG. 25A) and the image where pixels have been inserted (FIG. 25B) in the case of inserting pixels in such a manner that the pixel insertion position is offset line by line of fast scan in certain cycles.

In the example shown in FIGS. 25A and 25B, a pattern is repeated in cycles across a width for 7 scan lines (corresponding to a length of 7 pixels) and the pixel insertion position is offset by one pixel line by line within one cycle. This limits a line formation of inserted pixels to a certain length. However, even in this case, when the pixel insertion positions coincide with the properties (cycle and angle) of a screening pattern used in screening, a defect may occur in the image.

These defects result from that image processing to correct misregistration, executed on a screened image, deforms the shape of a screening pattern used in the screening.

### SUMMARY

According to an aspect of the present invention, an image forming apparatus that performs registration control when forming an image on a recording medium includes: a correction value determining unit that determines correction values for correcting misregistration of an image; an image processing unit that alters at least a part of a pattern included in the image based on the correction values determined by the correction value determining unit; and a correction processing unit that performs alteration on the image, in which at least a part of the pattern has been altered by the image processing unit, based on the correction values determined by the correction value determining unit.

### BRIEF DESCRIPTION OF THE DRAWINGS

Exemplary embodiments of the present invention will be described in detail based on the following figures, wherein:

FIG. 1 illustrates an image forming apparatus to which an exemplary embodiment of the invention is applied;

FIG. 2 shows a functional structure of a controller in the present exemplary embodiment;

FIGS. 3A and 3B are diagrams to explain a screen pattern alteration made by a screening unit to adapt the screening pattern for correction for skew misregistration in the present exemplary embodiment;

FIGS. 4A and 4B show the result of the screening by the altered screening pattern according to the present exemplary embodiment;

FIGS. 5A, 5B, and 5C are diagrams to explain a screen pattern alteration made by the screening unit to adapt the screening pattern for correction for a bowed image in the present exemplary embodiment;

FIG. 6 shows an example of a matrix of threshold values of a screening pattern;

FIGS. 7A and 7B are diagrams to explain a screen pattern alteration made by the screening unit to adapt the screening pattern for correction for magnification deviation of an image in the present exemplary embodiment;

FIG. 8 is a diagram to explain another example of a screen pattern alteration made by the screening unit to adapt the screening pattern for correction for magnification deviation of an image in the present exemplary embodiment;

FIGS. 9A and 9B show the result of the screening by the altered screening pattern according to the present exemplary embodiment;

FIGS. 10A through 10D are diagrams to explain memory space required in the case where misregistration correction is performed before and after screening;

FIG. 11 shows a functional structure of a controller in the case where misregistration correction is performed before and after screening;

FIG. 12 shows an image produced by normal screening on an image processed by pre-correction processing;

FIG. 13 shows an image produced by post-correction processing on the image shown in FIG. 12;

FIG. 14 shows an image produced by screening with a screening pattern altered to adapt for image processing for post-correction on the image processed by pre-correction processing;

FIG. 15 shows an image produced by post-correction processing on the image shown in FIG. 14;

FIG. 16 is a diagram to explain a concrete example of screening, which shows an example of a rasterized multilevel image at 600 dpi;

FIG. 17 is a diagram to explain a concrete example of screening, which shows a matrix of threshold values of a screening pattern;

FIG. 18 is a diagram to explain a concrete example of screening, which shows a screening pattern in which black and white dots correspond to on and off dots of image data after binarized;

FIGS. 19A, 19B, and 19C are diagrams to explain a concrete example of screening, which respectively show enlarged view of sections in FIGS. 16 to 18;

FIGS. 20A and 20B are diagrams to explain a correction method by image processing for skew misalignment;

FIGS. 21A and 210B are diagrams to explain a correction method by image processing for magnification misalignment;

FIG. 22 shows a general structure of image processing functions for related art;

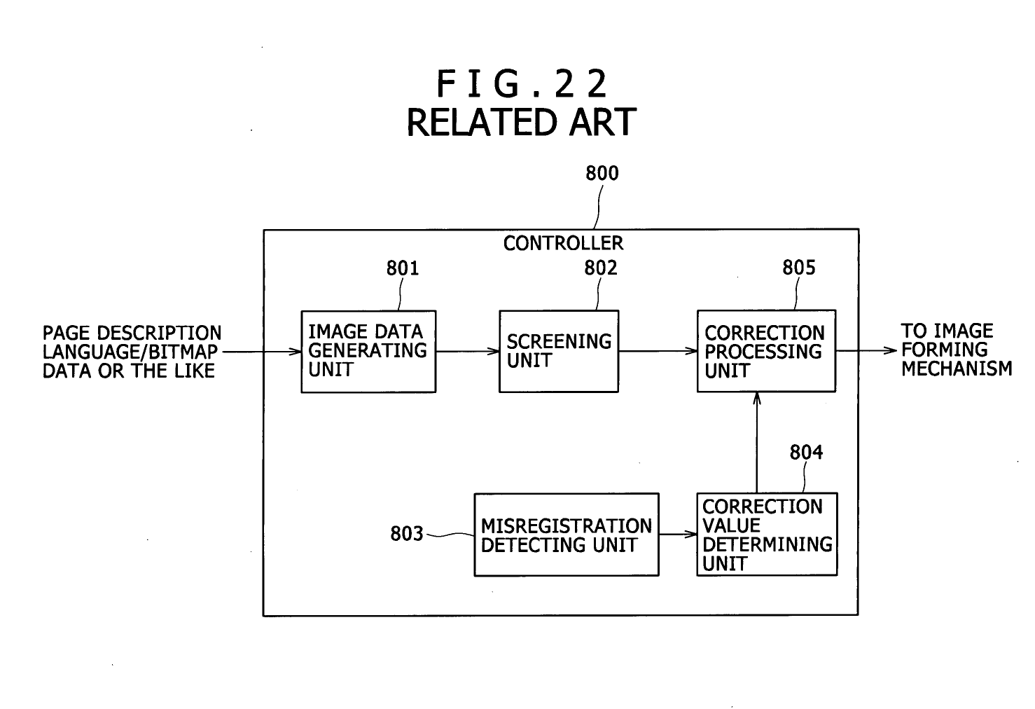

FIGS. 23A, 23B, and 23C schematize defects which occur in an image when skew correction is performed by image processing;

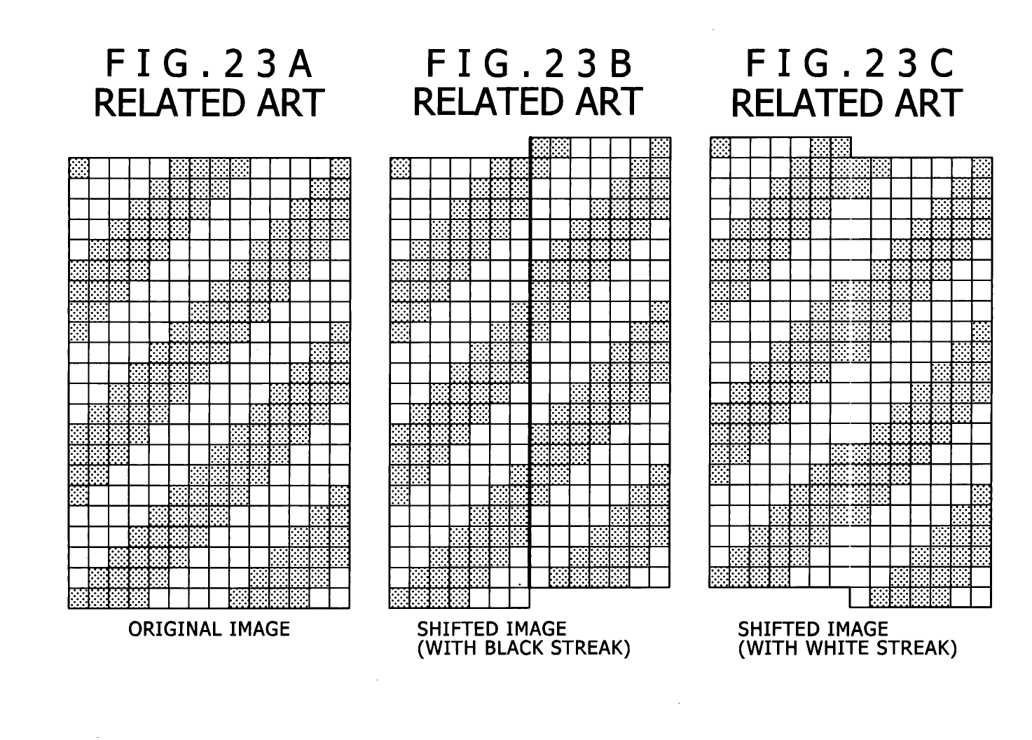

FIGS. 24A and 24B illustrate images before and after inserting pixels into image data to correct magnification misalignment in the fast-scanning direction; and

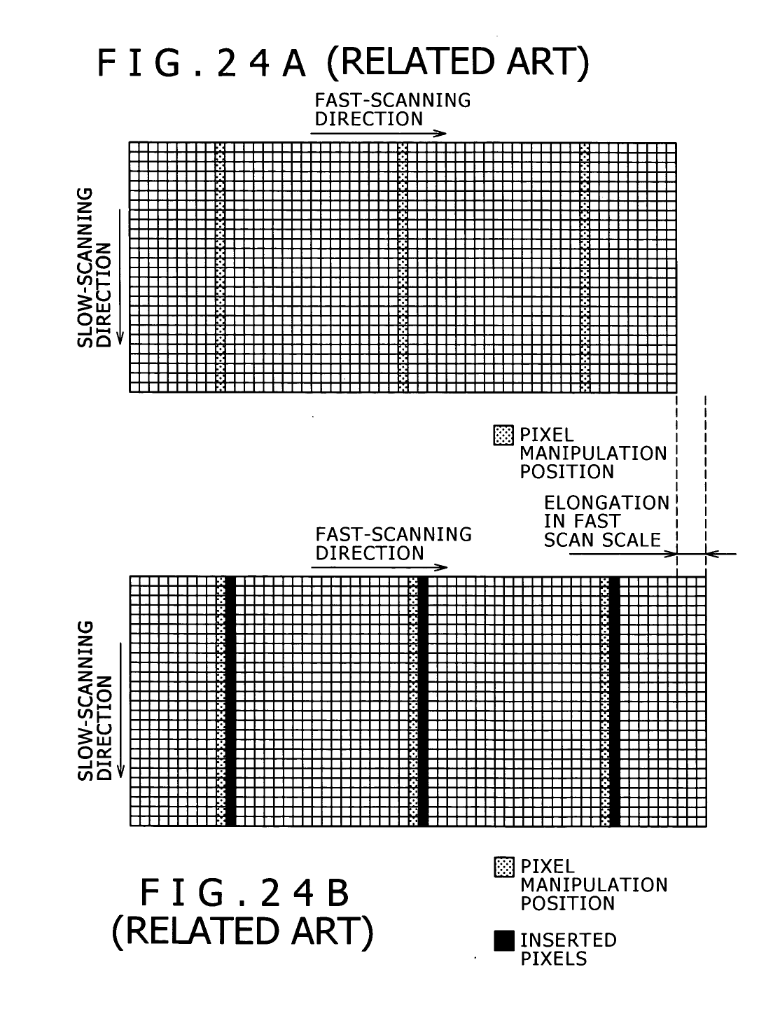

FIGS. 25A and 25B illustrate images before and after inserting pixels in such a manner that the pixel insertion position is offset line by line of fast scan in certain cycles.

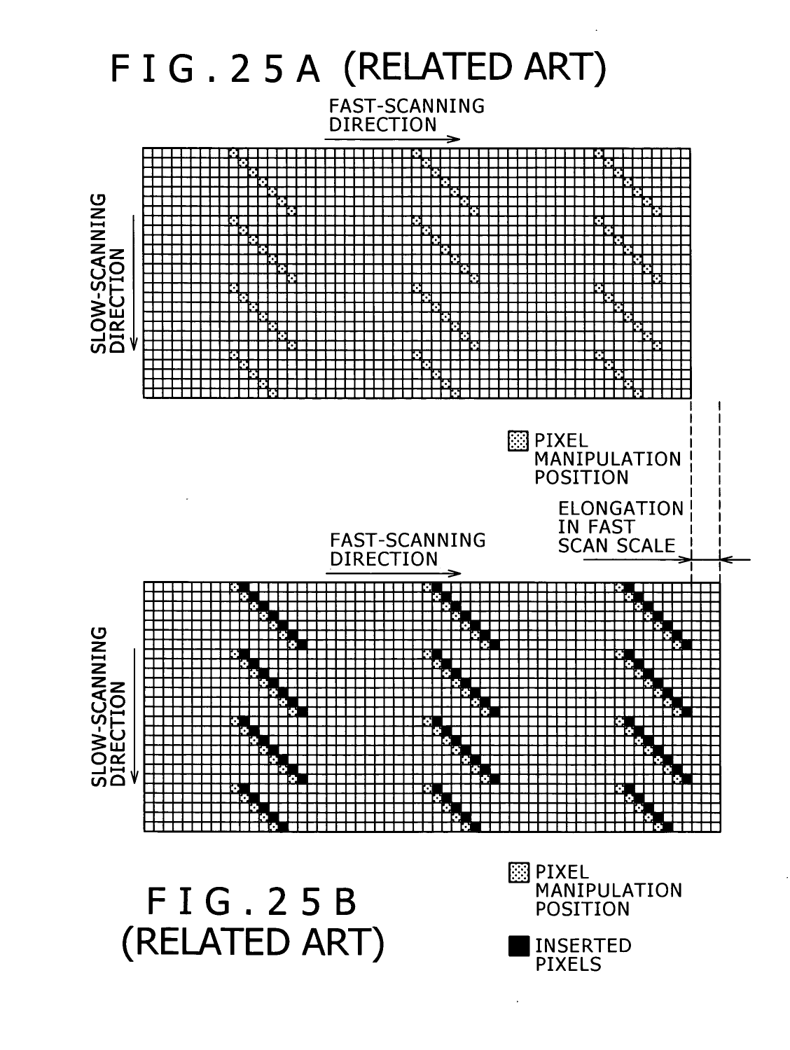

### DETAILED DESCRIPTION

Exemplary embodiments of the present invention will now be described in detail with reference to the accompanying drawings.

According to an exemplary embodiment of the invention, the process for correcting misregistration by image processing on a screened image includes, as preprocessing, altering a screening pattern used for the screening of the image beforehand, according to the image alteration to be made by the correction. Specifically, processing that is inverse to the alteration processing by the correction is performed before the correction. Thereby, the screening pattern after the correction is performed keeps its original shape as if it were not altered by the correction. This manner restrains the deformation of the screening pattern.

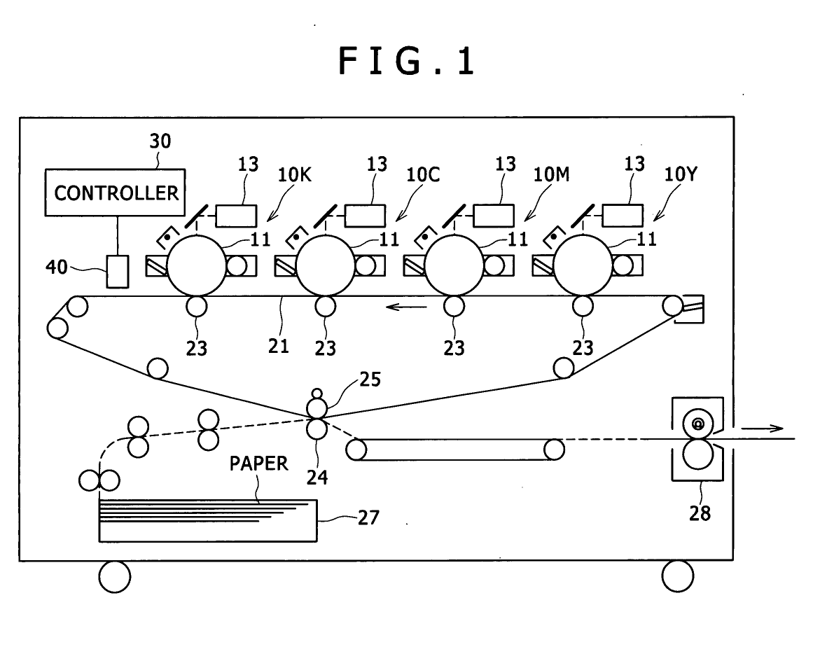

FIG. 1 illustrates an image forming apparatus to which an exemplary embodiment of the invention is applied.

This image forming apparatus is a so-called tandem type digital color electrophotographic printer. As shown in FIG. 1, this image forming apparatus includes image forming units 10 which form images, exposure units 13 as a printing function, which form electrostatic latent images on photoconductor drums 11 in the image forming units 10, and a transfer belt 21 as an intermediate transfer member, which carries a multi-color image into which toner images, each carried by and transferred from the photoconductor drums 11, are merged. The four image forming units 10 are provided which are respectively for yellow (Y), magenta (M), cyan (C), and black (K) colors. In the following description, where their distinction is needed, the image forming units are denoted as 10Y, 10M, 10C, 10K; otherwise, they are simply denoted as image forming units 10. Inside the transfer belt 21, first transfer rollers 23 are provided in position to face and contact the photoconductor drums 11 of each image forming unit 10 in order to transfer toner images onto the transfer belt 21. In a so-called second transfer position where a multi-color toner image carried by the transfer belt is transferred onto paper, a second transfer roller 24 and its mating roller 25 which is provided inside the transfer belt 21 are placed. Moreover, the apparatus includes a paper cassette 27 which houses sheets of paper which is a recording medium and a fixing device 28 for heat fixing a multi-color toner image onto paper. Furthermore, the image forming apparatus includes a controller 30 for image processing for misregistration correction and color misregistration sensors 40 which read a pattern for color registration control formed in a certain region on the transfer belt 21.

The controller 30 generates image signals such as digital image signals of an image obtained from an image data input section such as an image input terminal IIT and a pattern image for color misregistration control and supplies the image signals to the exposure units 13 so that the corresponding image will be transcribed onto the transfer belt 21. The controller 30 obtains the results of detection of a pattern for color misregistration control from the color misregistration sensors 40, analyzes the amount of color misregistration, based on the obtained information, and makes correction required. These functions of the controller 30 are realized by, for example, a program-controlled CPU (Central Processing Unit) or the like. The controller 30 is equipped with a nonvolatile ROM (Read Only Memory) and a readable/writable RAM (Random Access Memory) as memories. In the ROM, software programs for control of operations to be performed by the controller, such as image formation, color misregistration detection, and correction, and image information representing patterns for color misregistration control are stored. In the RAM, many kinds of information which are obtained during the operation of the image forming apparatus, such as the values of counters, job execution count, and information about previous detection of color misregistration (e.g., detection of misregistration) are stored.

To the exposure units 13 provided for each color, digital image signals are supplied via the controller 30; these signals are created through conversion by an image processing device (not shown) from image data obtained from, for example, the IIT(Image Input Terminal), an external personal computer (PC) and the like. A color misregistration sensor 40 is a reflective sensor which makes a pattern for color misregistration control (a ladder patch of toners or chevron patch), which is formed on the transfer belt 21, focused onto a detector element made up of a PD (Photo Diode) sensor or the like and outputs a pulse when the centroidal line of the patch aligns with the center line of the detector. For example, two color misregistration sensors 40 are placed downstream of the most downstream image forming unit 10K in FIG. 1 and along the fast-scanning direction, in order to detect relative color misregistration for a pattern for color misregistration control, namely, a patch formed through the image forming units 10. As light emitting elements of the color misregistration sensors 40, two infrared LEDs (with a wavelength of 880 nm) are used and configured such that the amount of light emission of each LED can be adjusted (for example, in two steps) to ensure stable pulse output.

In each of the image forming units 10Y, 10M, 10C, 10K for the four colors, various units for image formation are provided around the photoconductor drum 11 as an image carrier in a similar fashion; that is, a charging unit which charges the photoconductor drum 11, a development unit which develops a toner image on the photoconductor drum 11 illuminated by the exposure unit 13, a clear which removes toner residues from the surface of the photoconductor drum 11 after transfer of a toner image onto the transfer belt 21, and so on. It is also possible that the arrangement of the image forming units 10 includes an additional image forming unit for a specific color adapted for a special imaging material, e.g., corporate color, which is not used for normal color image formation, along with so-called regular colors for imaging, yellow (Y), magenta (M), cyan (C), and black (K). It is also possible to use five or more colors including dark yellow besides the above four Y, M, C, and K colors as the colors for regular use. In this exemplary embodiment, the axial direction of the photoconductor drum 11 as the image carrier is assumed to be fast-scanning direction and the direction in which a toner image moves along with the rotation of the photoconductor drum 11 is slow-scanning direction.

Here, a multi-beam ROS (Raster Output Scanner) is used in the exposure unit 13 which illuminates the photoconductor drum 11 in each of the image forming units 10 for the four colors. The ROS is made up of multiple light sources each made up of multiple laser diodes (LDs). After laser beams emitted from the multiple light sources are collimated by a collimate lens, the beams are scanned by the deflective reflection surface of a rotary polygon mirror. By a converging lens, the beams are focused-onto a laser spot by which scan (fast scan) and illumination on the surface of the photoconductor drum 11 takes place. As the photoconductor drum 11 is rotated by a driving section, it is exposed to the laser spot in the direction (slow scan) perpendicular to the laser scan (fast scan), thus exposure to two-dimensional illumination and latent image formation can be realized.

As the transfer belt 21, an endless belt of, for example, flexible synthetic resin film such as polyamide is used, which is provided by shaping the film material into a belt and joining the ends of the belt by welding or the like. This transfer belt 21 is tightly stretched by driving rollers and backup rollers to make a loop in which at least a part of the belt is substantially straightened. Along the substantially straight section of the transfer belt 21, the image forming units 10Y, 10M, 10C, 10K for the four colors and their mating first transfer rollers 23 are arranged, spaced at given intervals in a substantially horizontal direction. In the example shown in FIG. 1, the image forming unit 10Y for yellow, the image forming unit 10M for magenta, the image forming unit 10C for cyan, and the image forming unit 10K for black are arranged in order in the direction from upstream to downstream in the direction in which the transfer belt 21 moves during a transfer operation. Toner images of each individual color formed by the image forming units 10 are merged in order on the belt, as the transfer belt 21 moves; thereby a multi-color toner image is formed on the transfer belt 21. The movement of the transfer belt 21 is timed with the transportation of paper and the multi-color toner image formed on the transfer belt 21 is transferred onto paper in the position where the second transfer roller 24 and its mating roller 25 exist. Then, the paper having the multi-color toner image transferred onto it is transported to the fixing device 28 where the image is heat fixated on the paper which is further carried and ejected out to a catch tray provided outside the chassis of the image forming apparatus.

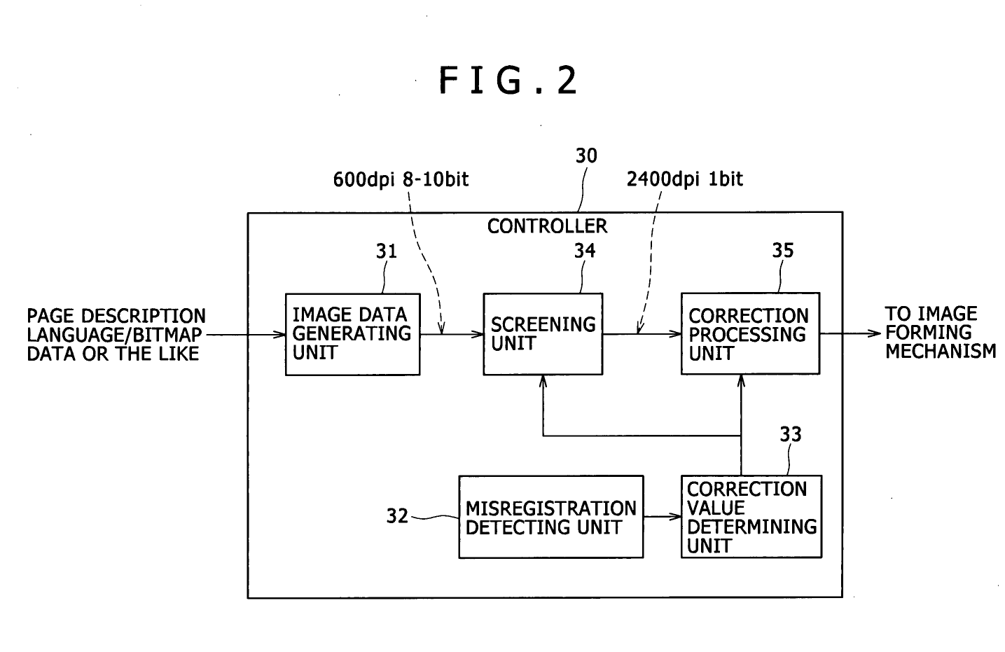

FIG. 2 shows a functional structure of the controller 30 in the present exemplary embodiment.

Referring to FIG. 2, the controller 30 of the exemplary embodiment includes an image data generating unit 31, a misregistration detecting unit 32, a correction value determining unit 33, a screening unit 34 which executes screening, and, a correction processing unit 35 which performs correction for misregistration. In this configuration, the functions of the image data generating unit 31, misregistration detecting unit 32, correction value determining unit 33, screening unit 34, and correction processing unit 35 are realized by the CPU controlled by software programs stored in, for example, a nonvolatile ROM. The controller 30 is also equipped with a memory (graphic memory), which is not shown particularly, for writing and transforming images (screening patterns and images to be printed) for image processing by the screening unit 34 and correction processing unit 35 which will be discussed later.

In the above configuration, the image data generating unit 31 receives input of an image described in a page description language and bitmap data as an image to be printed and converts (rasterizes) the input image into a multilevel image at a certain resolution. In the present exemplary embodiment, at this time, an image at a 600 dpi resolution in 8 to 10 bits (256 to 1024 gray-scale levels) will be generated.

The misregistration detecting unit 32 obtains results of detection of a pattern for misregistration control by the color misregistration sensors 40, analyzes them, and determines whether color misregistration occurs and the amount of misregistration, as noted above in reference to FIG. 1.

The correction value determining unit 33 calculates correction values required to compensate for the amount of color misregistration detected by the misregistration detecting unit 32. For example, if a skew misregistration is corrected, the correction value determining unit 33 calculates values as the solution to the following: the pixels arranged in the fast-scanning direction are block shifted at every which dots and by what amount of shift in dots in slow-scanning direction. If magnification deviation in the fast-scanning direction is corrected, the correction value determining unit 33 calculates a value as the solution to the following: one pixel is additionally inserted (or deleted) at every which dots into (from) the pixels arranged in the fast-scanning direction.

The screening unit 34 performs image data screening for each color and each type of object (e.g., photograph, characters, etc.) to convert the image data into binary data. Here, the above-mentioned image at the 600 dpi resolution in 8 to 10 bits (256 to 1024 gray-scale levels) will be converted into a binary image at a 2400 dpi resolution in 1 bit (two gray-scale levels). The screening unit 34 separates text and images (T/I separation) and selects a screening pattern good for a range of gray-scale values in which the object to be processed is represented. The screening unit 34 selects and retrieves a screening pattern from a file of screening patterns stored in the memory (such as the above-mentioned ROM provided for the controller 30) and uses the screening pattern for screening.

Now, binarizing an image by screening is explained in detail.

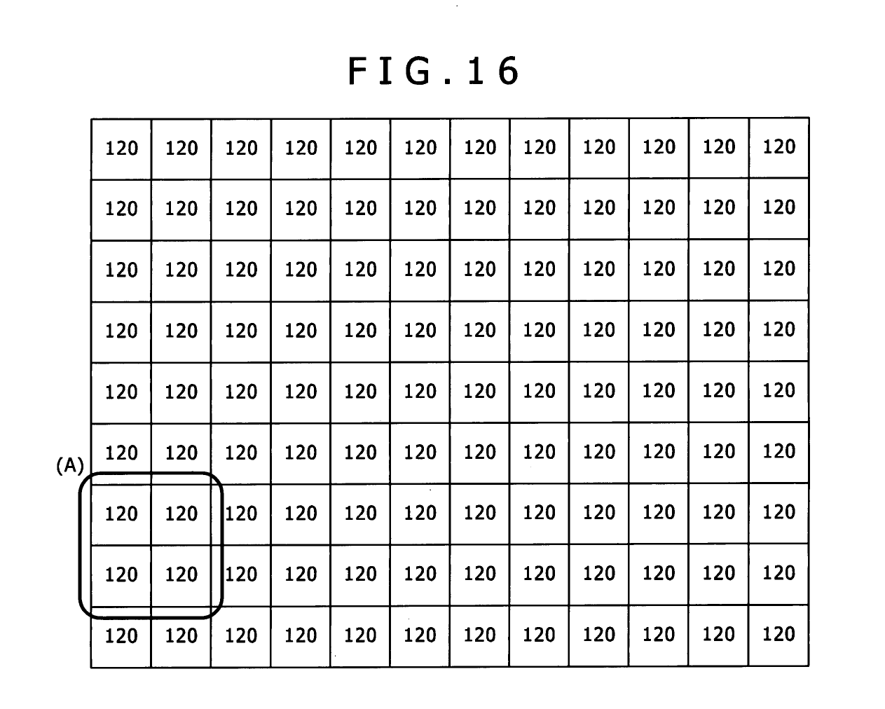

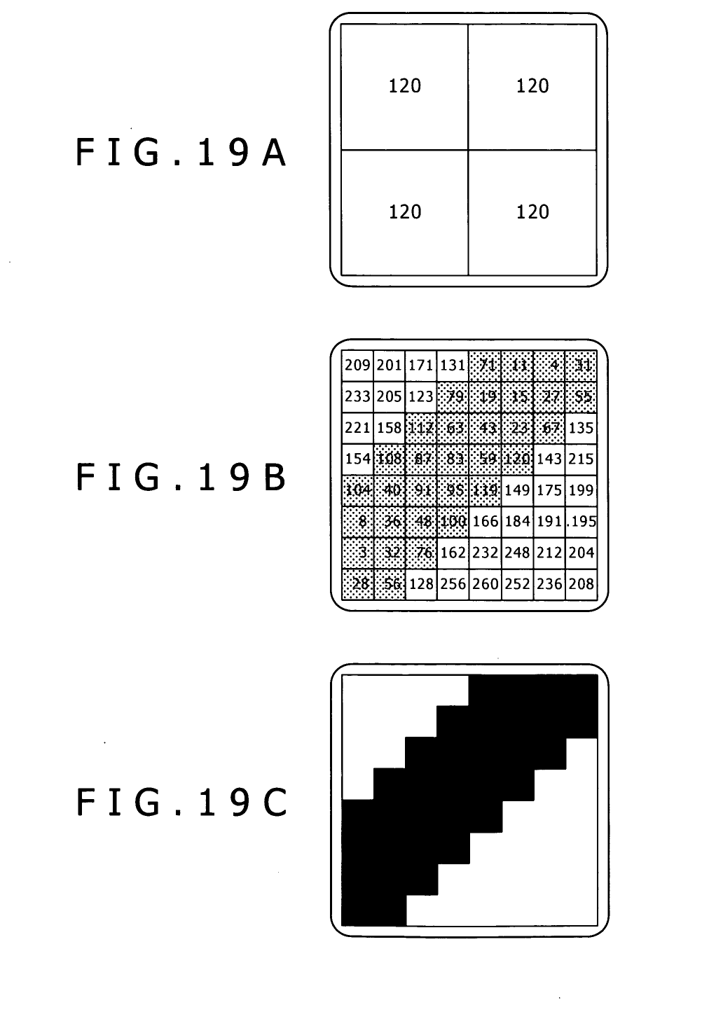

FIGS. 16 through 18 are diagrams to explain concrete examples of screening. FIGS. 19A, 19B, and 19C respectively show partially enlarged views of FIGS. 16 to 18. These figures present an example where a multilevel image at 600 dpi (288 gray-scale values) is screened (binarized) through dither screening, thus the resolution is converted into 2400 dpi.

FIG. 16 shows a rasterized multilevel image at 600 dpi. Specifically, one of cells arranged in a grid is one pixel and a value “120” marked in each cell denotes a gray-scale value of 120 among 288 gray-scale values. The gray-scale value of 120 means a density value of 120/288=42%. FIG. 19A shows an enlarged view of a section (A) surrounded by a frame in FIG. 16.

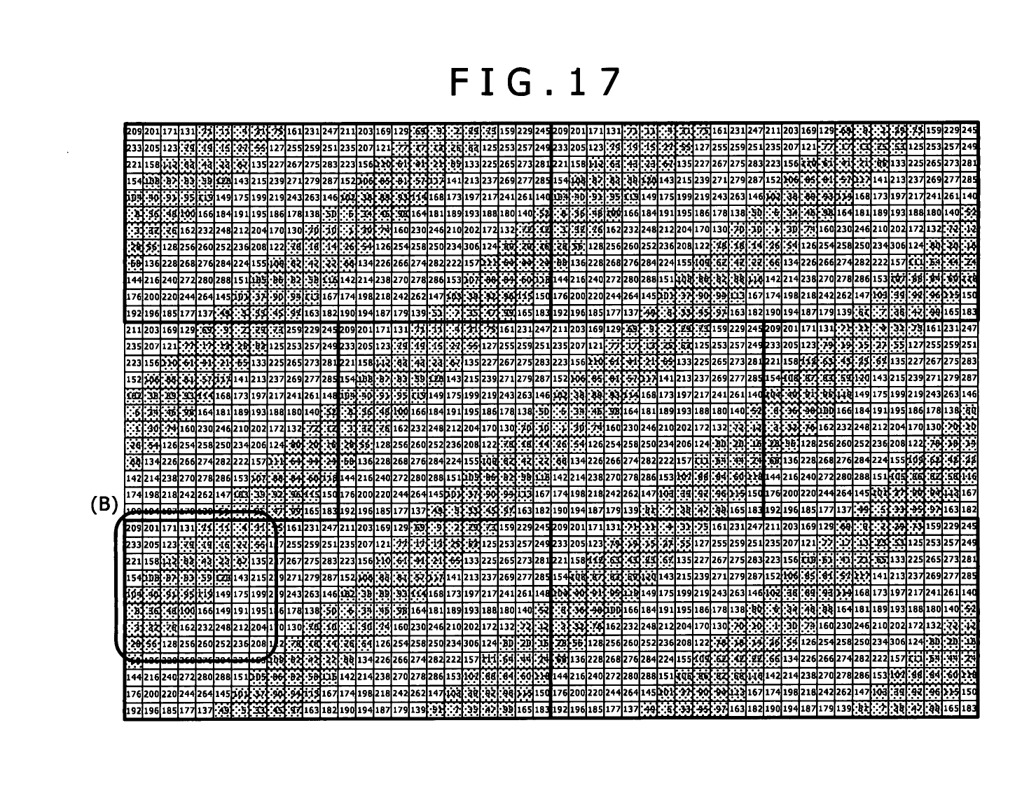

FIG. 17 shows a matrix of threshold values of a screening pattern. FIG. 19B shows an enlarged view of a section (B) surrounded by a frame in FIG. 17. A matrix of threshold values is a collection of data representing the thresholds for binarization pixel by pixel with regard to output resolution for representing a screening pattern structure (hereinafter referred to as a screening structure). In the example shown here, threshold values from 1 to 288 at 2400 dpi are arranged according to a predetermined consistent rule.

In the screening, a gray-scale value of 120 in the multilevel image data at 600 dpi shown in FIG. 16 and FIG. 19A is compared to the threshold values specified pixel by pixel at 2400 dpi shown in FIG. 17 and FIG. 19B. For each pixel at 2400 dpi, if the gray-scale value exceeds the threshold value predefined for the pixel, the pixel is set on (it appears as a white cell in FIG. 17) and, if the gray-scale value is less than the threshold value, the pixel is set off (it appears as a gray cell in FIG. 17). In this way, all pixels are binarized.

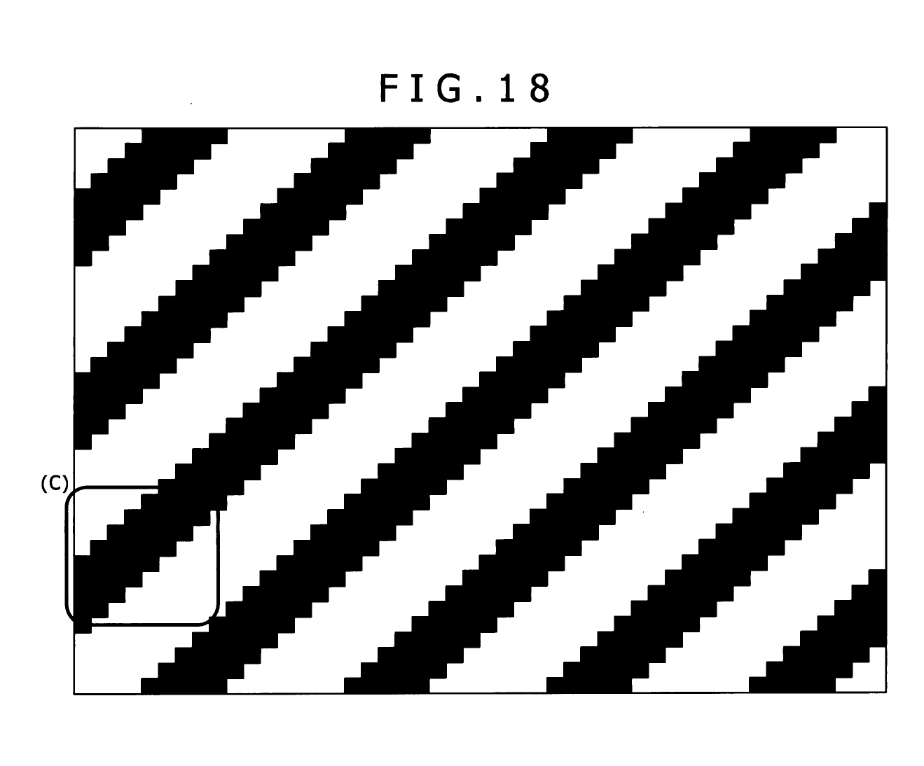

FIG. 18 represents a screening pattern of image data made up of on and off pixels after binarization, wherein an on pixel is black and an off pixel is white. FIG. 19C shows an enlarged view of a section (C) surrounded by a frame in FIG. 18. When a screening pattern is actually formed on a recording medium such as paper, the image like the one shown in FIG. 18 and FIG. 19C will be formed.

In addition to executing the above ordinary screening, the screening unit 34 of the present exemplary embodiment obtains correction values calculated by the correction value determining unit 33 and performs image processing to alter the shape (pattern) of a screening pattern, based on the obtained correction values. This image processing is the process inverse to the image alteration process for misregistration correction to be performed by the correction processing unit 35. In other words, this process is preprocessing to alter a screening pattern so that the screening pattern like the one shown in FIG. 18 keeps its original shape (that is, the shape shown in FIG. 18) even after the correction is made by the correction processing unit 35. The image processing for screening pattern alteration will be detailed later.

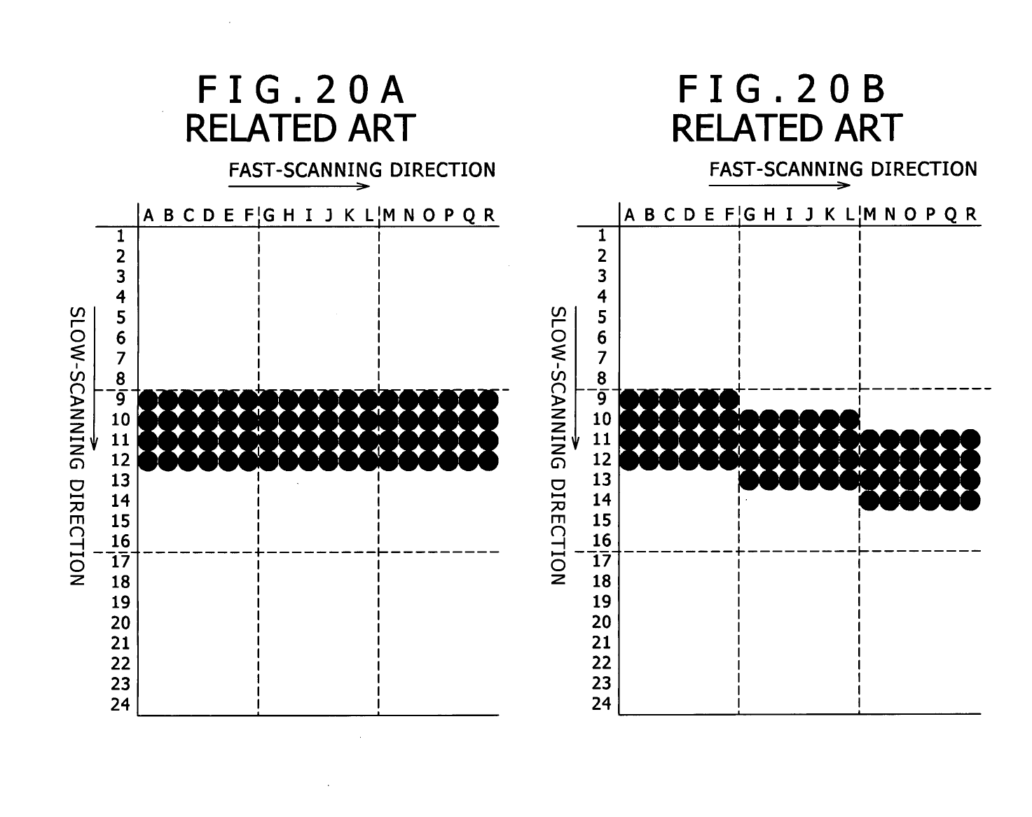

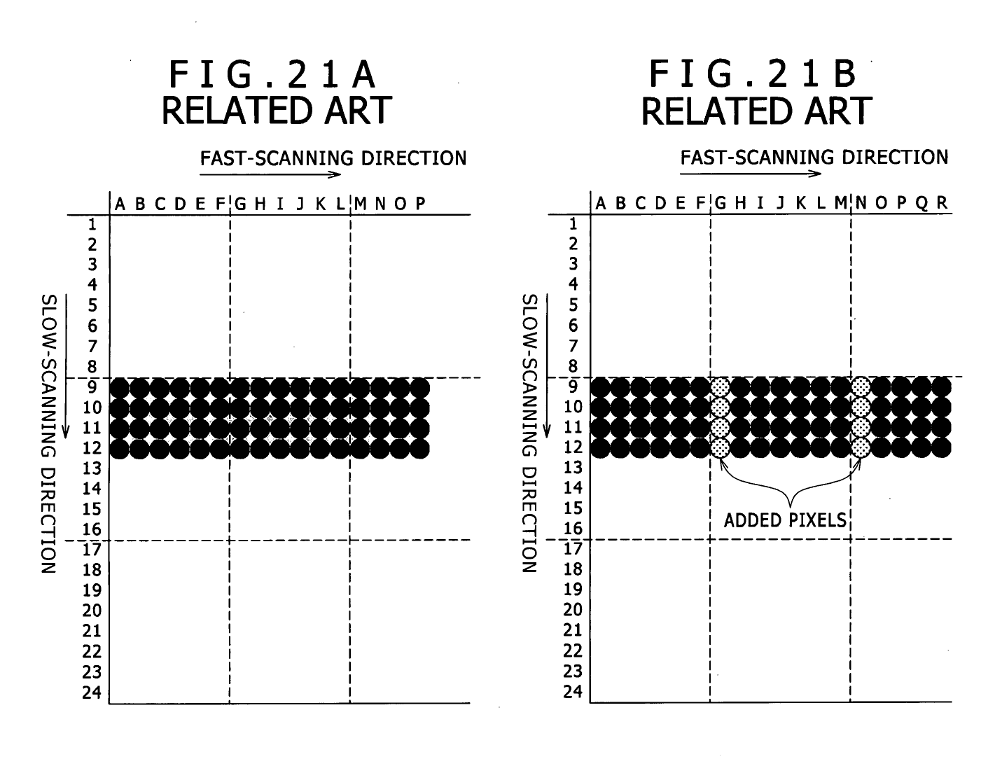

The correction processing unit 35 corrects the image to be printed, after processed by the screening unit 34, based on the correction values calculate by the correction value determining unit 33. The method of correction made by the correction processing unit 35 is the same as the conventional method shown in FIGS. 20 and 21. In effect, the correction method includes partially shifting the pixels of an image, adding pixels in certain positions in an image, and, inversely, deleting (cutting) pixels from the image, thus rectifying misregistration detected by the misregistration detecting unit 32.

Next, screening pattern alterations which are made by the screening unit 34 are discussed in depth.

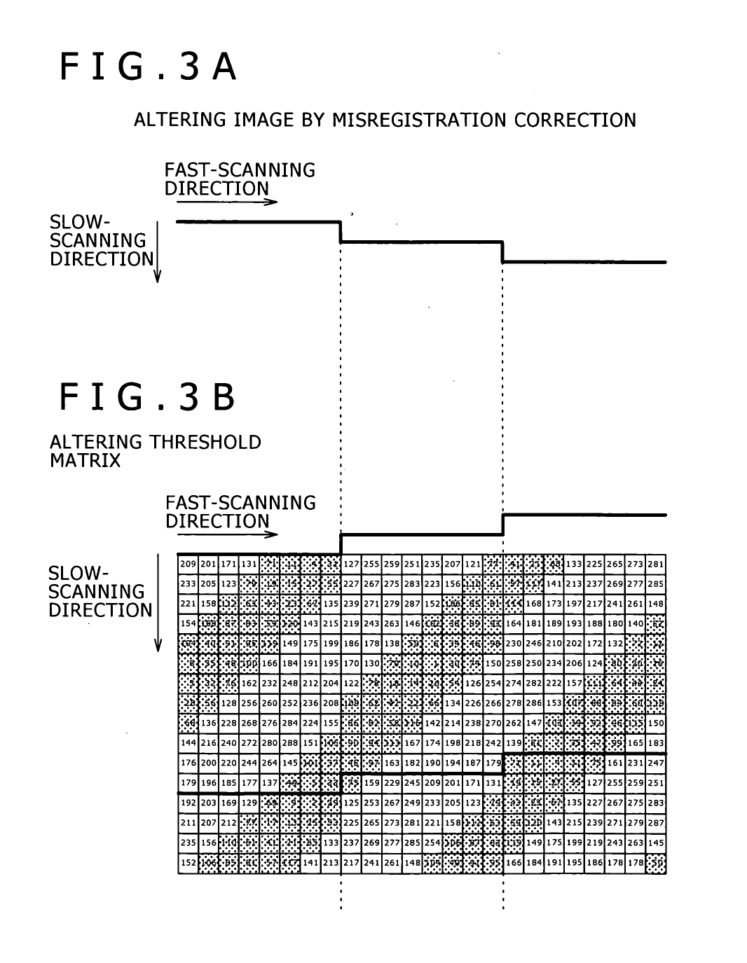

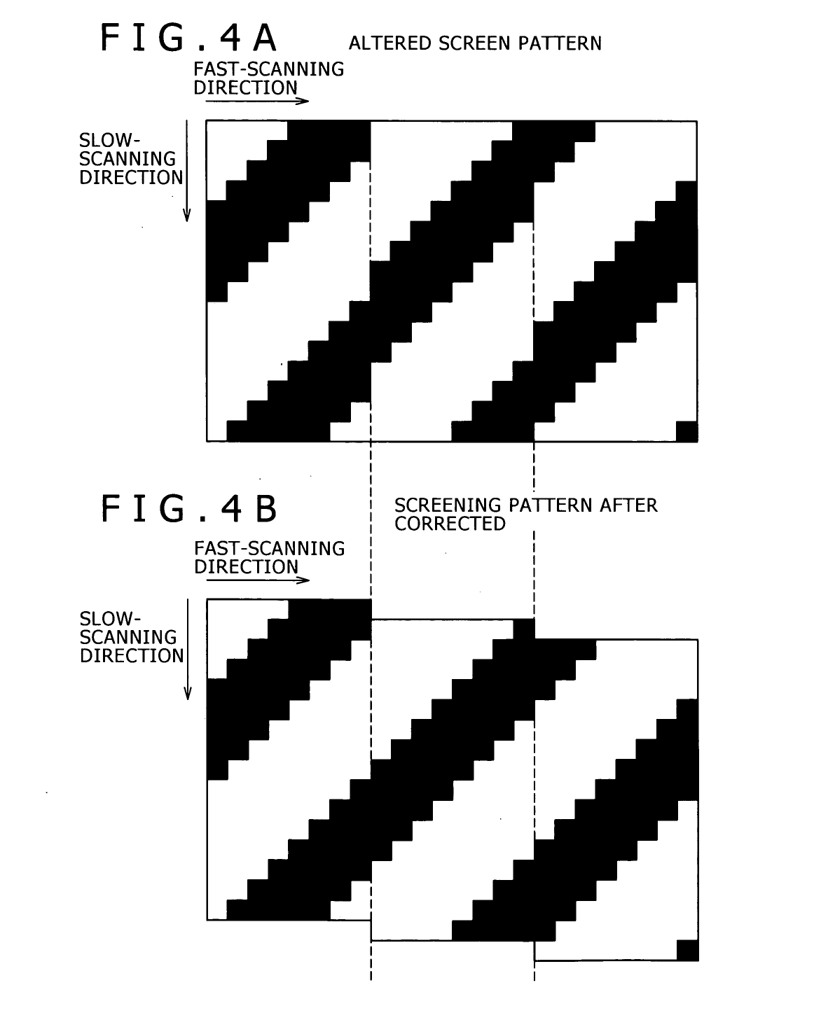

FIGS. 3A and 3B are diagrams to explain a screen pattern alteration made by the screening unit 34 to adapt the screening pattern for correction for skew misregistration. FIGS. 4A and 4B show the result of the screening by the altered screening pattern. Here, the same diagonal line screening pattern as shown in FIGS. 16 to 19 is used as an example.

In the example shown here, as shown in FIG. 3A, the correction processing unit 35 will sequentially block shift every eight pixels in the fast-scanning direction by one line in the slow-scanning direction (by one line down in the figure) to correct skew misregistration. The details of this correction are based on the correction values calculated by the correction value determining unit 33, as noted above. Thus, by obtaining these correction values, the screening unit 34 can also know the details on what correction will be made by the correction processing unit 35 (that is, how the image will be altered by the correction).

Then, the screening unit 34 obtains the correction values from the correction value determining unit 33 and makes an alteration inverse to the alteration to be made by the correction processing unit 35 on the matrix of threshold values of the screening pattern, as shown in FIG. 3B. In the example shown in FIG. 3A, the correction processing unit 35 sequentially block shifts every eight pixels in the fast-scanning direction by one line in the slow-scanning direction, as described above. Therefore, the screening unit 34 alters the screening pattern such that it sequentially block shifts every eight pixels in the fast-scanning direction by one line in a reverse direction in the slow-scanning direction (by one line up in the figure).

FIG. 4A shows binary image data (screening pattern) after the screening by the altered matrix of threshold values shown in FIG. 3B. Referring to FIG. 4A, it is seen that the diagonal lines of the screening pattern block shift by one dot up every eight dots in the fast-scanning direction, reflecting the above alteration made by the screening unit 34.

FIG. 4B shows an image produced after the correction processing unit 35 performs the correction on the image having the altered screening pattern shown in FIG. 4A. As described above, to rectify the image, the correction processing unit 35 block shifts every eights dots in the fast scan line by one line down in the slow-scanning direction. As a result, the screening pattern after corrected maintains the original diagonal lines as shown in FIG. 18.

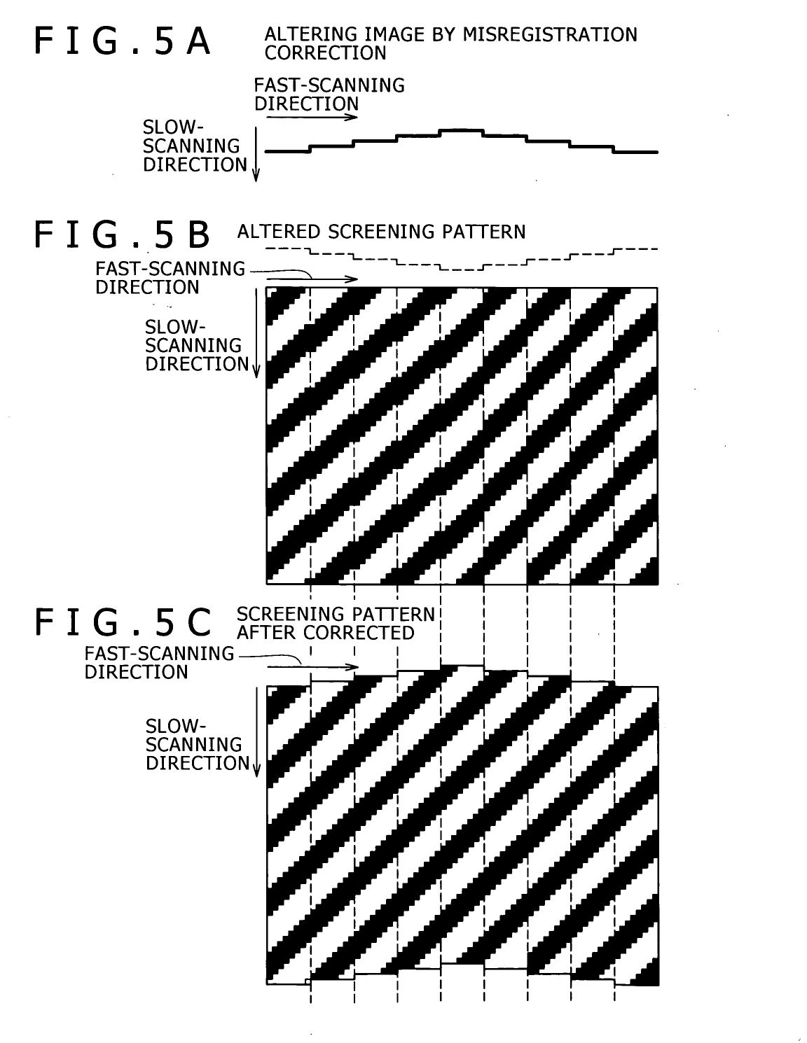

FIGS. 5A, 5B, and 5C are diagrams to explain a screen pattern alteration made by the screening unit 34 to adapt the screening pattern for correction for a bowed image. The method of correction for a bowed image is basically the same as the above correction for skew misregistration. In this example as well, the same diagonal line screening pattern as shown in FIGS. 16 to 19 is used.

In the example shown here, as shown in FIG. 5A, the correction processing unit 35 will make an alteration such that it block shifts every eight pixels in the fast scan line by one line to make block shifts in five levels and the center block protrudes in a reverse direction in the slow-scanning direction (upward in the figure) above the right end and left end blocks. That is, pixel blocks shift by one line up in the slow-scanning direction over five levels sequentially from the left end and shift down by one line sequentially in the slow-scanning direction over five levels down to the right end.

The screening unit 34 obtains the correction values from the correction value determining unit 33 and makes an alteration inverse to the alteration to be made by the correction processing unit 35 on the matrix of threshold values of the screening pattern. That is, as shown in FIG. 5B, the screening unit 34 alters the screening pattern as follows: supposing that the image is divided into nine strip-shaped regions A to I each having a width of eight pixels in the fast-scanning direction, the screening unit 34 shifts each region one line down in the slow-scanning direction from the left end region A to the center region E and shifts each region one line up reversely in the slow-scanning direction from the region E to the right end region I.

FIG. 5C shows an image produced after the correction processing unit 35 performs the correction on the image having the altered screening pattern shown in FIG. 5B. As described above, the correction processing unit 35 alters the image such that it block shifts every eight pixels in the fast scan line by one line to make block shifts in five levels and the center block protrudes in a reverse direction in the slow-scanning direction (upward) above the right end and left end blocks. As a result, the screening pattern after corrected maintains the original diagonal lines as shown in FIG. 18.

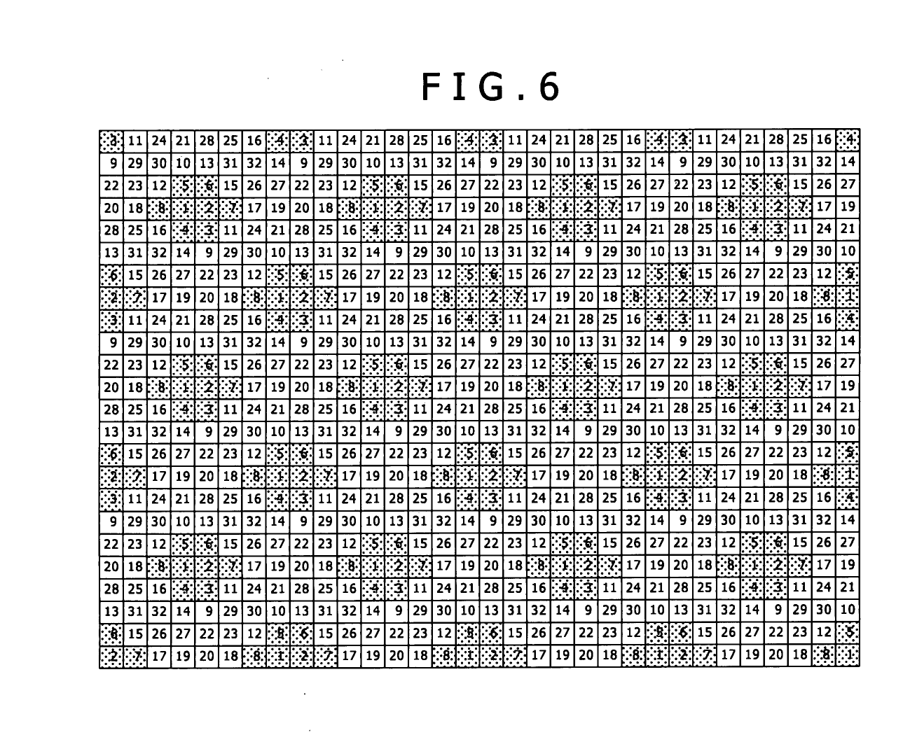

FIG. 6 shows another example of a matrix of threshold values of a screening pattern different from the example shown in FIG. 18. In the screening pattern variant shown here, dot marks of certain size are arranged at given intervals. Individual dot marks have the same size and the same shape.

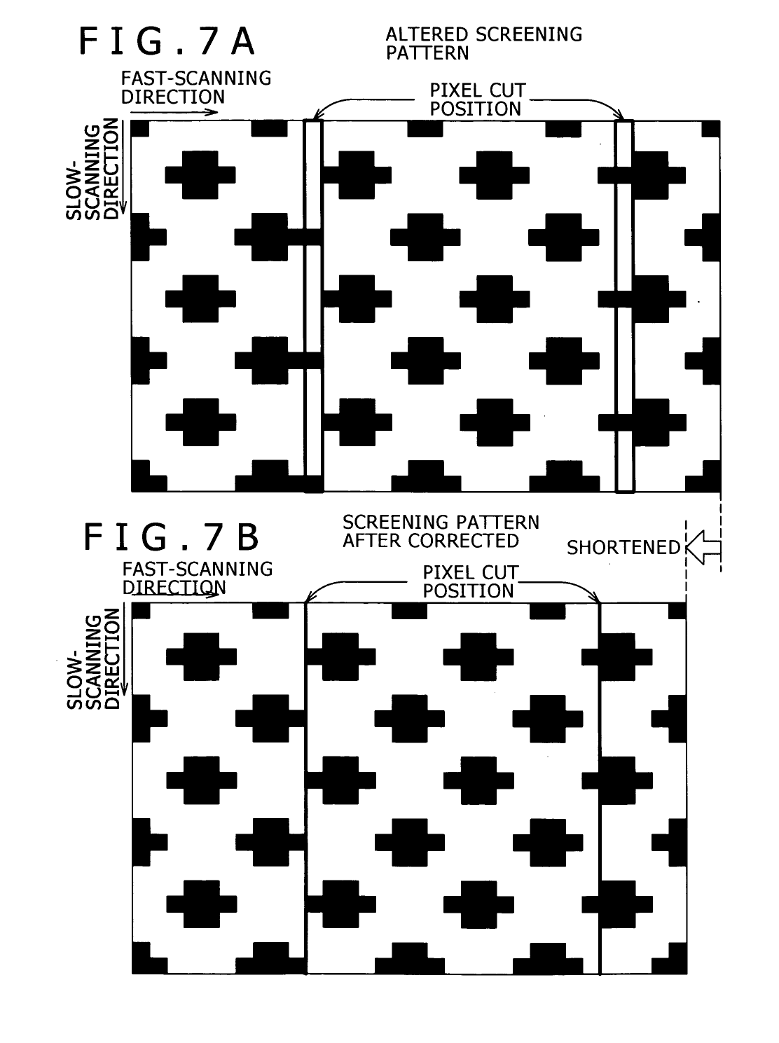

FIGS. 7A and 7B are diagrams to explain a screen pattern alteration made by the screening unit 34 to adapt the screening pattern for correction for magnification deviation of an image. Here, a screening pattern based on the matrix of threshold values shown in FIG. 6 is used as an example.

In this example, the correction processing unit 35 deletes a given number of pixels at certain intervals from the arrangement of pixels in the fast-scanning direction to reduce the width of the image in the fast-scanning direction, thus correcting the magnification deviation. In the example shown here, by deleting the pixels in two strip zones surrounded by a bold frame, the width of the image in the fast-scanning direction is shortened by two dots.

The screening unit 34 obtains the correction values from the correction value determining unit 33 and makes an alteration inverse to the alteration to be made by the correction processing unit 35 on the matrix of threshold values of the screening pattern, as shown in FIG. 7A. That is, the screening unit 34 inserts pixels which do not exist in the original screening pattern into the strip zones (pixel cut positions) surrounded by a bold frame from where the correction processing unit 35 deletes the pixels. In the example shown here, pixels are copied and inserted to fill one column in the slow-scanning direction at the left side of each pixel cut position surrounded by a bold frame. As a result, the dot marks in the positions where the pixels have been inserted are widened on one side (in the fast-scanning direction), different from the dot marks in other positions.

FIG. 7B shows an image produced after the correction processing unit 35 performs the correction on the image having the altered screening pattern shown in FIG. 7A. As described above, the correction processing unit 35 deletes the pixels in the pixel cut positions surrounded by a bold frame in FIG. 7A. As a result, the screening pattern after corrected maintains the original pattern where all dot marks of the same shape are arranged at equal intervals, as shown in FIG. 6.

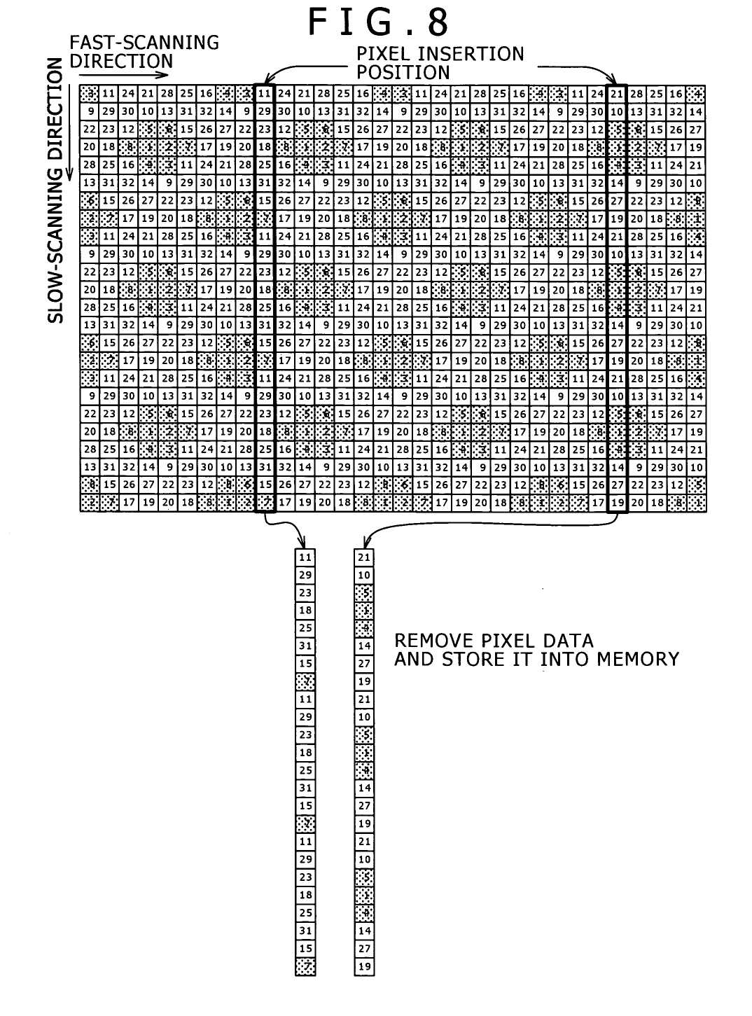

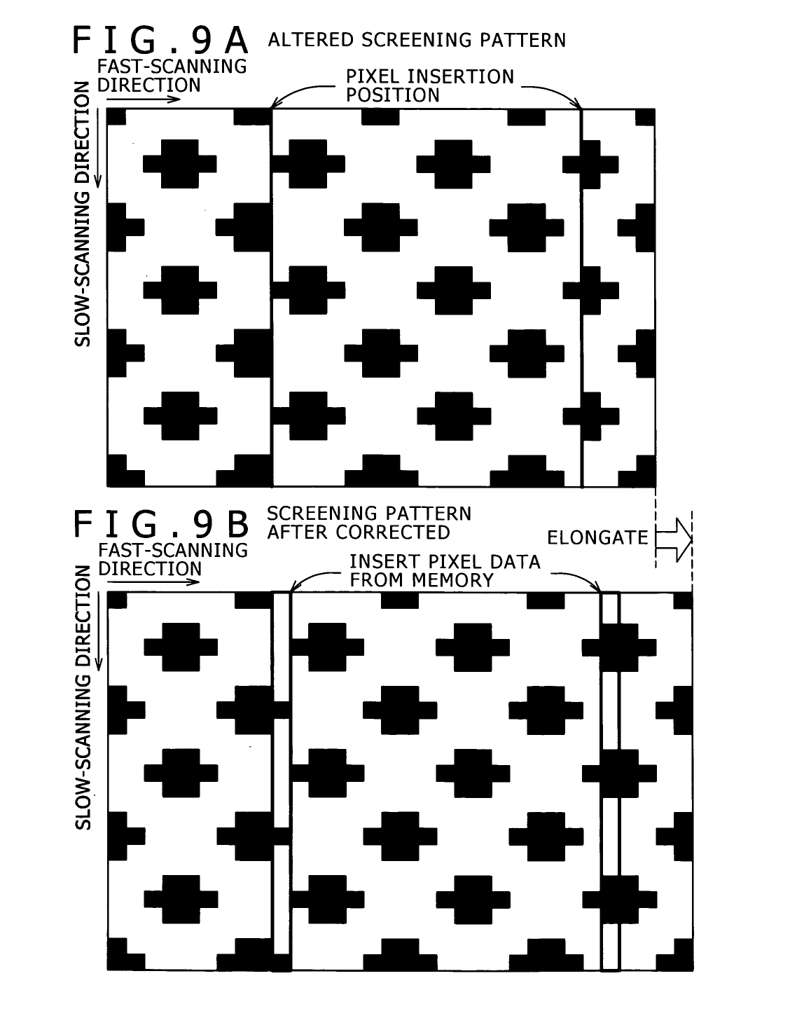

FIGS. 8 is a diagram to explain another example of an alteration to a matrix of threshold values of a screening pattern made by the screening unit 34 to adapt the screening pattern for correction for magnification deviation of an image. FIGS. 9A and 9B show the result of the screening by the altered screening pattern. In this example as well, the screening pattern based on the matrix of threshold values shown in FIG. 6 is used.

In this example, the correction processing unit 35 inserts a given number of pixels at certain intervals into the arrangement of pixels in the fast-scanning direction to elongate the width of the image in the fast-scanning direction, thus correcting the magnification deviation. Specifically, by inserting pixels in two positions marked by bold lines in FIG. 9A, the width of the image in the fast-scanning direction is elongated by two dots.

The screening unit 34 obtains the correction values from the correction value determining unit 33 and makes an alteration inverse to the alteration to be made by the correction processing unit 35 on the matrix of threshold values of the screening pattern, as shown in FIG. 8 and FIG. 9A. That is, the screening unit 34 deletes the pixels in the positions marked by bold frames in FIG. 8, corresponding to the pixel insertion positions marked by bold lines in FIG. 9A where the correction processing unit 35 will insert pixels. As a result, the dot marks positioned in the pixel insertion positions shrink sideways (in the fast-scanning direction), different from the dot marks in other positions, as shown in FIG. 9A. The data for the pixels deleted from the screening pattern is retained on the memory (graphic memory), not shown, which is used for image processing for screen pattern alteration.

FIG. 9B shows an image produced after the correction processing unit 35 performs the correction on the image having the altered screening pattern shown in FIG. 9A. As described above, the correction processing unit 35 inserts pixels into the insertion positions marked by bold lines in FIG. 9A. At this time, the data for the pixels stored in the above-mentioned memory (the data for the pixels deleted from the screening pattern) is inserted. As a result, the screening pattern after corrected maintains the original pattern where all dot marks of the same shape are arranged at equal intervals, as shown in FIG. 6.

Meanwhile, when misregistration correction is performed by image processing, there is a need for a memory space enough to accommodate copying all image segments to be altered for correction into memory and manipulating the segments. For example, if a total of 48 pixels have to be shifted throughout an image for correction for skew misregistration, a memory area for 48 lines is needed. It is conceivable to reduce the memory space required for image processing for such correction by carrying out two stages of misregistration correction before and after screening.

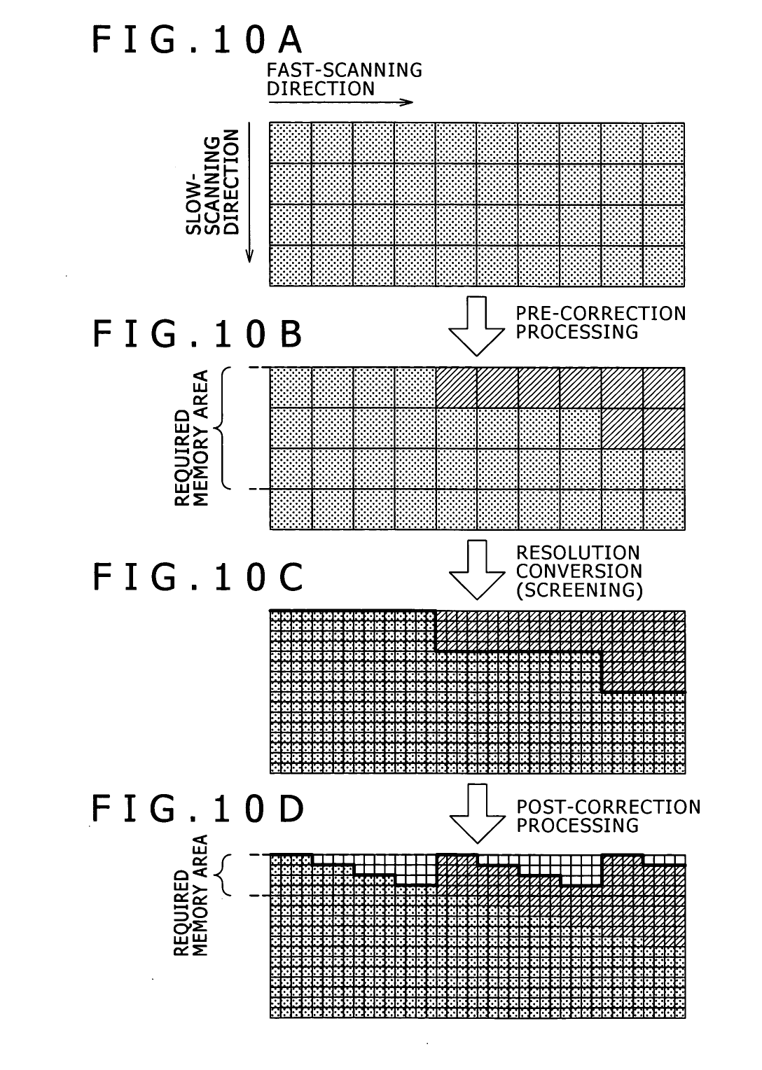

In the case of screening in the area coverage modulation method, an image initially generated as multilevel image data, for example, at a 600-dpi resolution, using 8 to 10 bits (for 256 to 288 gray-scale levels) is converted into a binary image, for example, at a 2400-dpi resolution in 1 bit (two gray-scale levels) by screening. As FIGS. 10A to 10D show, a general correction for an image at a rough resolution is performed before screening (pre-correction processing) and more exact correction for the image at a fine resolution is performed after the screening (post-correction processing).

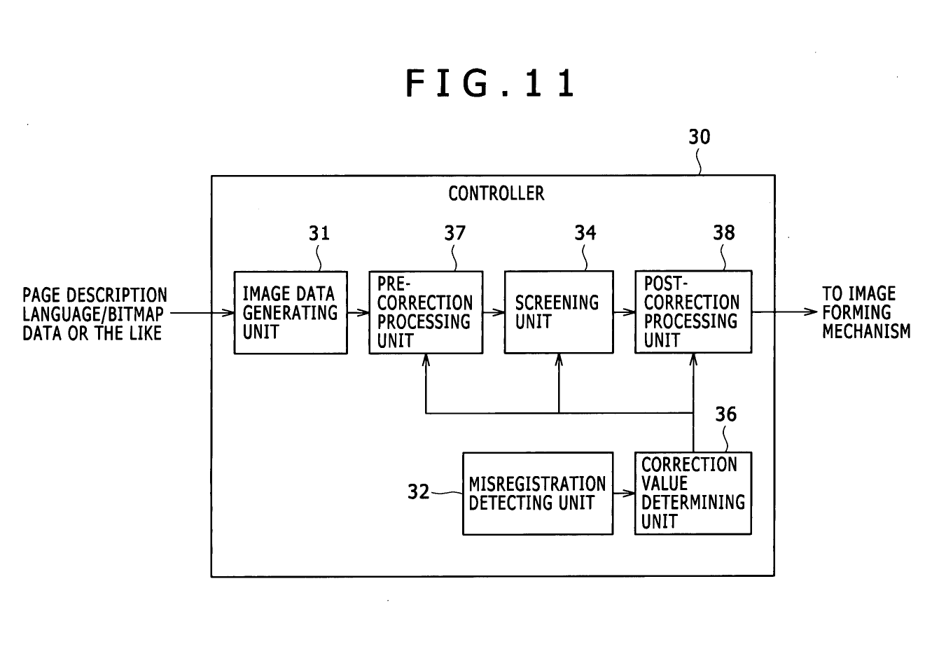

FIG. 11 shows a functional structure of a controller 30 in the case where misregistration correction is performed before and after screening.

The controller 30 shown in FIG. 11 includes an image data generating unit 31, a misregistration detecting unit 32, a correction value determining unit 36, a pre-correction processing unit 37 for executing pre-correction processing, a screening unit 34, and a post-correction processing unit 38 for executing post-correction processing. In this configuration, the functions of the image data generating unit 31, misregistration detecting unit 32, and screening unit 34 are the same as corresponding functions in the controller 30 shown in FIG. 2. Therefore, these units are assigned the same reference numbers and their explanation is not repeated.

The correction value determining unit 36 calculates correction values required to compensate for the amount of color misregistration detected by the misregistration detecting unit 32. However, the correction value determining unit 36 calculates correction values at two levels; one for image alteration (correction) to be made for pre-correction by the pre-correction processing unit 37 and the other for image alteration (correction) to be made for post-correction by the post-correction processing unit 38.

The pre-correction processing unit 37 receives an image generated by the image data generating unit 31 and alters the image according to the correction values for pre-correction processing calculated by the correction value determining unit 36.

The post-correction processing unit 38 receives an image at a resolution converted through the process of screening by the screening unit 34 and alters the image according to the correction values for post-correction processing calculated by the correction value determining unit 36.

Here, referring to FIGS. 10A to 10D again, the details of the pre-correction processing and the post-correction processing are discussed in depth.

FIG. 10A shows a 600-dpi resolution image using 8 bits generated by the image data generating unit 31 (gray cells represent an image). On this image, the pre-correction processing unit 37 first executes pre-correction processing. FIG. 10B shows an image processed by the pre-correction processing. Pixel shifts in the image processed by the pre-correction processing correspond to stepwise block shifts every four horizontal pixels for a 2400-dpi resolution image produced after screening. Thus, in the example shown in FIG. 10B, the memory area required to copy and manipulate the segments to be altered by the correction is for three lines. Thus, in the memory used by the pre-correction processing unit 37, it is necessary to allocate at least a memory space enough to store three lines of pixel data at 600 dpi. Pixels from which image data is removed by a partial image shift by pre-correction processing are filled with white data or the like (shaded cells in FIG. 10B).

Next, the screening unit 34 executes screening (resolution conversion) on the image processed by the pre-correction processing, thus converting the 600-dpi image using 8 bits into the 2400-dpi image using 1 bit. FIG. 10C shows an image resulting from this resolution conversion. Referring to FIG. 10C, it is seen that, after the image altered by the pre-correction processing is converted into the 2400 dpi image, in the latter image, block shifts of every 16 dots arranged in the fast-scanning direction by 4 dots in the slow-scanning direction take place (blank cells in FIG. 10C are pixels having no image data (containing white data) due to the shifts).

Next, the post-correction processing unit 38 executes post-correction processing on the image at the changed resolution. FIG. 10D shows an image processed by the post-correction processing. In this image, stepwise block shifts every four horizontal pixels have been done by the pre-correction processing. Therefore, as shown in FIG. 10D, block shifts are only repeated every four horizontal pixels at 2400 dpi in the post-correction processing. Specifically, after block shifts of every four dots in the fast-scanning direction by one dot in the slow-scanning direction three times, a return to the top position occurs without shifting the next four dots and block shifts of every four dots are performed three times again. By repeating this cycle, every four dots in the fast-scanning direction are block shifted by one dot throughout the image. Because stepwise block shifts every four horizontal pixels are thus repeated, the memory area required to copy and manipulate the segments to be altered by the correction is for four lines only, as shown in FIG. 10D. Thus, in the memory used by the post-correction processing unit 38, it is necessary to allocate at least a memory space enough to store four lines of pixel data at 2400 dpi.

Reduction in the required memory space by performing two stages of correction before and after resolution conversion by the screening is explained by using a concrete example.

For example, consider the case where the image width is 310 mm and correction is made to make line shifts by 48 pixels (lines) finally at a resolution of 2400 dpi. If this correction is performed only by the image processing after screening, the number of pixels to be manipulated across the image width is 29292 pixels and, therefore, the required memory space is 175.8 Kbytes (1406016 bits).

In contrast, assume that the two-stage correction method is applied, wherein pre-correction processing is executed on a 600-dpi image before screening and post-correction processing is executed on a 2400-dpi image after the screening. Then, in the pre-correction processing on the 600-dpi image, the number of pixels to be manipulated across the image width is 7324 pixels, the memory area required for correction is for 12 lines, and the required memory space is 11.0 Kbytes (87888 bits). In the post-correction processing on the 2400-dpi image, image processing is only performed for one line of the 600-dpi image, as noted above. Thus, 29292 pixels are to be manipulated across the image width, the memory area for four lines of the 2400-dpi image is required, and the required memory space is 14.6 Kbytes (117168 bits). The sum of the required memory spaces for both the pre-correction processing and the post-correction processing is 25.6 (11.0+14.6) Kbytes.

It is thus possible to reduce the required memory space greatly by carrying out two stages of correction before and after the screening by which resolution is converted.

Next, in the case where screening with a screen pattern altered by the present exemplary embodiment is executed in combination with the above two-stage correction method, screen pattern alteration is discussed.

First, when two-stage correction processing is performed without applying screening pattern alteration according to the present exemplary embodiment, how the screening pattern shape is deformed is shown.

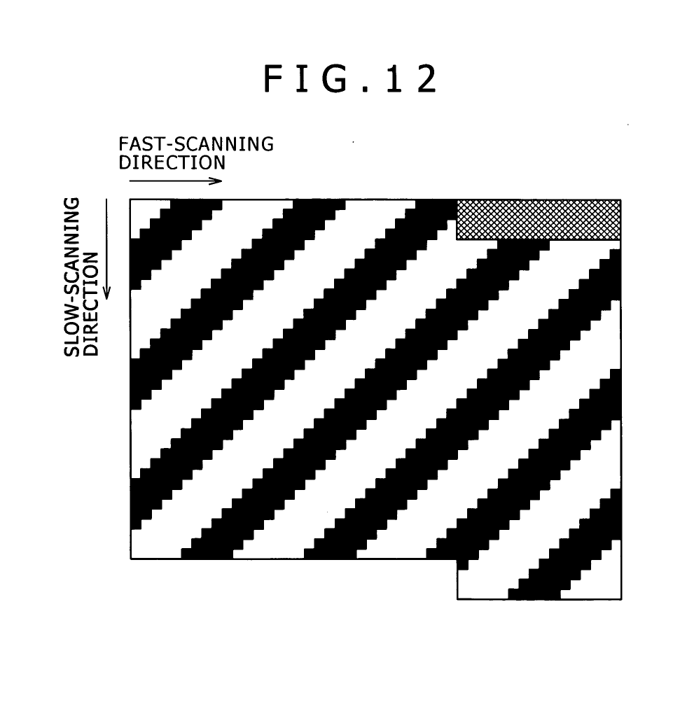

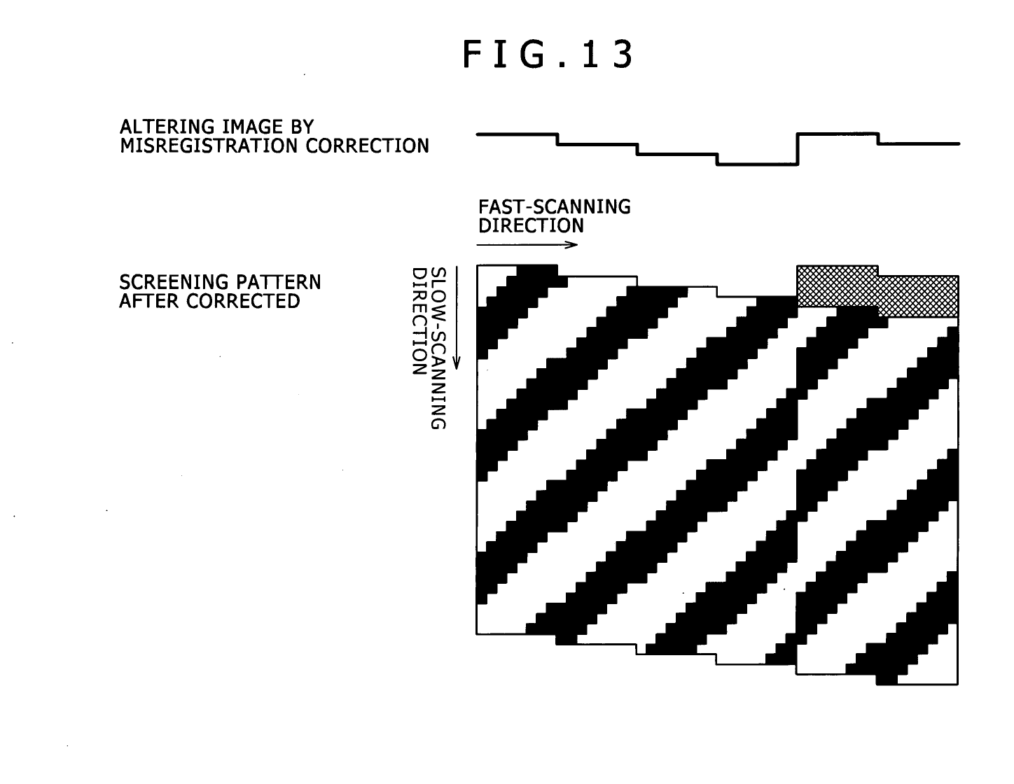

FIG. 12 shows an image produced by normal screening on an image processed by pre-correction processing. FIG. 13 shows an image produced by post-correction processing on the image shown in FIG. 12.

In the post-correction processing, the image is altered by line-by-line shifts in the slow-scanning direction and a cycle of recovery after every three time shifts is repeated. Consequently, as is apparent by referring to FIG. 13, in the screening pattern, large shoulders (across three pixels in the example shown here) appear in the boundary sections of shifts made in the pre-correction processing.

Then, the screening unit 34 makes line-by-line shifts of the screen pattern in a reverse direction to the slow-scanning direction at the same intervals as for the image alteration by the post-correction processing and repeats this operation every three time shifts. This process is inverse to the image alteration process by the post-correction processing.

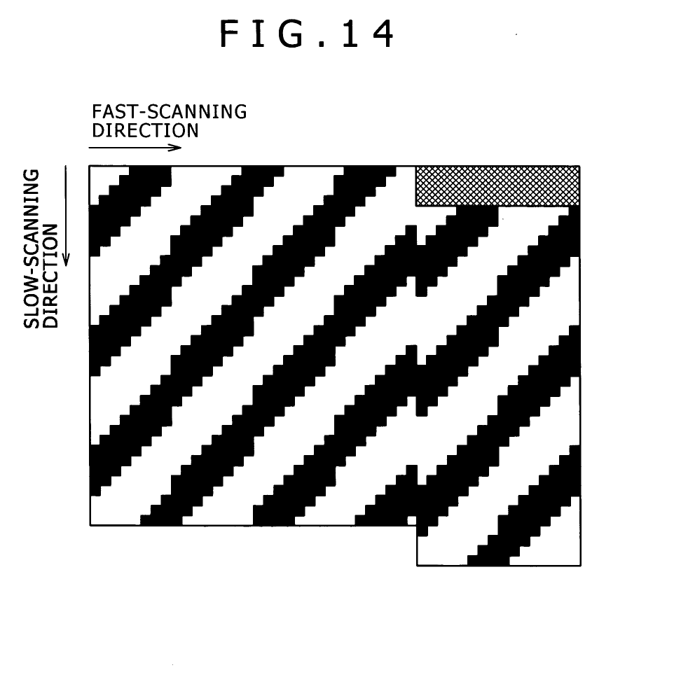

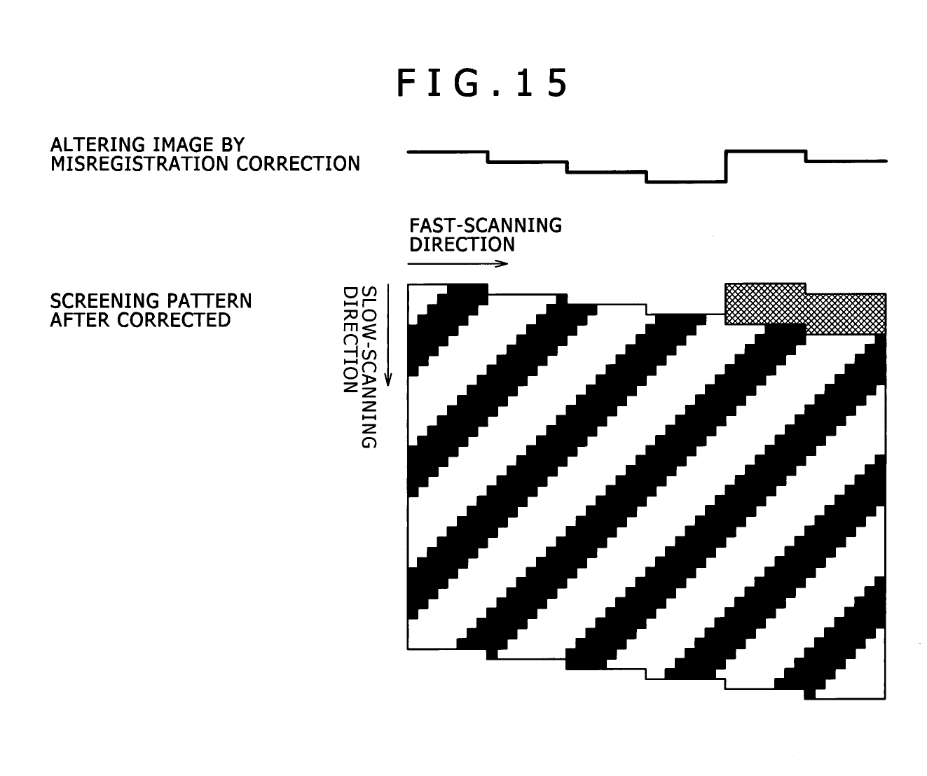

FIG. 14 shows an image produced by screening with a screening pattern altered as above on the image processed by pre-correction processing. FIG. 15 shows an image produced by post-correction processing on the image shown in FIG. 14.

As shown in FIG. 15, the screening pattern after the post-correction processing is executed keeps the original diagonal lines. Therefore, even if two stages of misregistration correction is performed before and after screening, it is advisable that the screening unit 34 makes an inverse alteration to the screening pattern to adapt for correction to be performed after the screening (post-correction processing).

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image forming apparatus that performs registration control when forming an image on a recording medium, comprising:
a correction value determining unit that determines correction values for correcting misregistration of an image;
an image processing unit that alters at least a part of a pattern included in the image based on the correction values determined by the correction value determining unit; and
a correction processing unit that performs alteration on the image, in which at least a part of the pattern has been altered by the image processing unit, based on the correction values determined by the correction value determining unit.

2. The image forming apparatus according to claim 1, wherein the alteration performed by the image processing unit is inverse alteration to the image alteration performed by the correction processing unit.

3. The image forming apparatus according to claim 1, wherein the pattern is a screening pattern which is used for screening.

4. The image forming apparatus according to claim 1,
wherein the misregistration includes skew misregistration,
the correction value determination unit determines correction values for correcting the skew misregistration, and
the correction processing unit performs an alteration on the image for correcting the skew misregistration based on the correction values for the skew misregistration, and
wherein the image processing unit divides the pattern into blocks of a certain width and shifts the blocks sequentially in a reverse direction to the direction of the alteration to be performed by the correction processing unit based on the correction values for the skew misregistration.

5. The image forming apparatus according to claim 1,
wherein the misregistration includes magnification deviation,
the correction value determination unit determines correction values for correcting the magnification deviation, and
the correction processing unit deletes or adds pixel data to constitute the image, thus performing an alteration to correct the magnification deviation based on the correction values for the magnification deviation, and
wherein the image processing unit adds or deletes pixel data to constitute the pattern inversely to the addition or deletion of the pixel data to be performed by the correction processing unit based on the correction values for the magnification deviation.

6. The image forming apparatus according to claim 5, further comprising a memory that stores pixel data to constitute the pattern deleted by the image processing unit, wherein the correction processing unit alters the image by adding the pixel data stored in the memory to the image.

7. An image forming apparatus that performs registration control when forming an image on a recording medium, comprising:
an image processing unit that alters at least a part of a pattern included in the image; and
a correction processing unit that performs alteration on the image, in which at least a part of the pattern has been altered by the image processing unit, for correcting misregistration,
wherein the image processing unit performs the alteration so that the pattern remains unchanged after the alteration by the correction processing unit.

8. The image forming apparatus according to claim 7, wherein the pattern is a screening pattern which is used for screening.

9. An image processing method for an image forming apparatus that forms an image on a recording medium, comprising:
determining correction values for correcting misregistration of an image;
altering at least a part of a pattern included in the image based on the correction values; and
performing alteration on the image, in which at least a part of the pattern has been altered, for correcting the misregistration based on the correction values.

10. The image processing method according to claim 9, wherein the alteration of at least a part of the pattern is inverse alteration to the image alteration to be performed for correcting the misregistration.

11. The image processing method according to claim 9, wherein at least a part of the pattern is altered so that the pattern remains unchanged after the image alteration to be performed for correcting the misregistration.

12. The image processing method according to claim 9,
wherein the misregistration includes skew misregistration,
correction values for correcting skew misregistration are determined in the determining step, and
alteration on the image is performed in the alteration performing step for correcting the skew misregistration based on the correction values for the skew misregistration, and
wherein, in the altering step, the pattern is divided into blocks of a certain width and the blocks are shifted sequentially in a reverse direction to the direction of the alteration on the image to be performed in the alteration performing step based on the correction values for the skew misregistration.

13. The image processing method according to claim 9,
wherein the misregistration includes magnification deviation,
correction values for correcting the magnification deviation are determined in the determination step, and
pixel data to constitute the image is added or deleted in the alteration performing step, thus performing alteration to correct the magnification deviation based on the correction values for the magnification deviation, and
wherein, in the altering step, pixel data to constitute the pattern is added or deleted inversely to the addition or deletion of the pixel data to be performed in the alteration performing step based on the correction values for the magnification deviation.

14. The image processing method according to claim 13,
wherein pixel data to constitute the deleted pattern is stored in a memory, and
the pixel data stored in the memory is added to the image for correcting the magnification deviation.

15. A storage medium readable by a computer, the storage medium storing a program of instructions executable by the computer to perform a function for image processing to form an image on a recording medium, the function comprising:
determining correction values for correcting misregistration of an image;
altering at least a part of a pattern included in the image based on the correction values; and
performing alteration on the image, in which at least a part of the pattern has been altered, for correcting the misregistration based on the correction values.
